(19) United States
(12) Patent Application Publication
(10) Pub. No.: US 2016/0209381 A1
(43) Pub. Date: Jul. 21, 2016

(54) BEVERAGE TEST APPARATUS

(71) Applicant: SHIR IFRACH, MIGDAL HAEMEK (IL)

(72) Inventor: SHIR IFRACH, MIGDAL HAEMEK (IL)

(21) Appl. No.: 14/987,784

(22) Filed: Jan. 5, 2016

(30) Foreign Application Priority Data
Jan. 21, 2015 (IL) 236841

(51) Int. Cl. G01N 30/90

(52) U.S. Cl. CPC G01N 30/90

(57) ABSTRACT

A beverage test apparatus, including a container, for containing beverage to be tested; an opening disposed on the container, the opening being covered by a one-way valve, for allowing entrance of the beverage into the container, and for disallowing exit therefrom, and a chromatography substance contained in the container, for changing a color of the chromatography substance upon presence of a certain ingredient, thereby a portion of beverage poured into the cup enters the container and is tested by the chromatography substance, and thereby the one-way valve disallows access of the chromatography substance to the beverage being drunk by the user, where the beverage test apparatus may further include a sticker attached to the container, for sticking the container to the drinking cup.

### CROSS-REFERENCE TO RELATED APPLICATIONS

This application claims the benefit of priority from Israel Patent Application No. 236841, filed Jan. 21, 2015, the disclosure of which is incorporated herein by reference.

### FIELD

The invention relates to the field of drinking cups. More particularly, the invention relates to a method and apparatus for testing a beverage contained in a cup.

### BACKGROUND

One of the problems of nightclubs is that one person might add an additive to the beverage of another person, for later dominating the other person.

### SUMMARY

The invention, in embodiments thereof, provides a method and apparatus for solving this problem.

Other aspects of the invention will become apparent as the description proceeds.

The invention, in embodiments thereof, is directed to a beverage test apparatus, comprising:
a container, for containing beverage to be tested;
an opening disposed on the container, the opening being covered by a one-way valve, for allowing entrance of the beverage into the container, and for disallowing exit therefrom; and
a chromatography substance contained in the container, for changing a color of the chromatography substance upon presence of a certain ingredient,
thereby a portion of beverage poured into the cup enters the container and is tested by the chromatography substance,
and thereby the one-way valve disallows access of the chromatography substance to the beverage being drunk by the user.

### BRIEF DESCRIPTION OF THE DRAWINGS

Embodiments, features, and aspects of the invention are described herein in conjunction with the following drawings in which:

FIG. 1 is a sectional view of an apparatus for detecting undesired additives to a beverage;

FIG. 2 is a sectional view of the apparatus for detecting undesired additives to a beverage, according to another embodiment; and

FIG. 3 is a sectional view of the apparatus for detecting undesired additives to a beverage, according to another embodiment.

The drawings are not necessarily drawn to scale.

### DETAILED DESCRIPTION

The invention will be understood from the following detailed description of embodiments, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

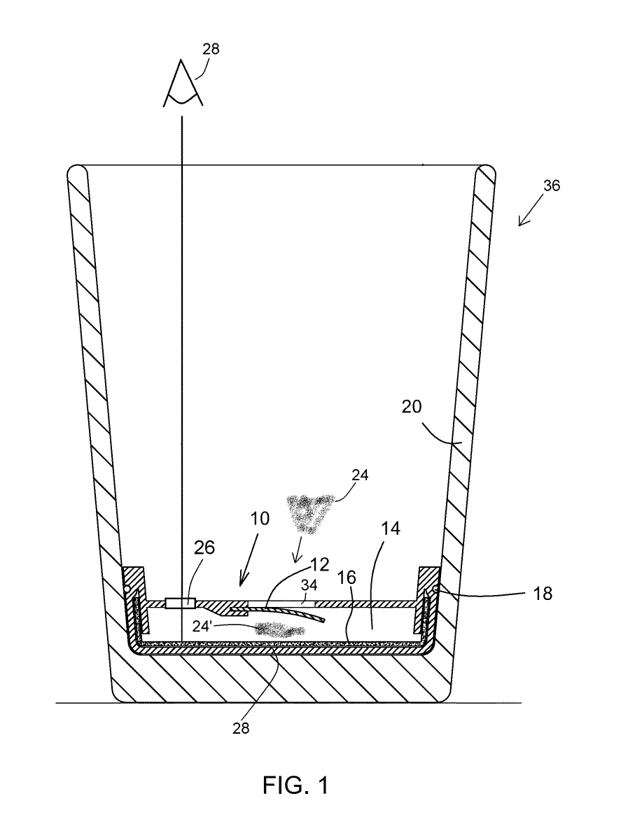

FIG. 1 is a sectional view of an apparatus for detecting undesired additives to a beverage.

A beverage test apparatus 10 for detecting undesired additives to a beverage, includes a container 14, being significantly smaller than a cup 36, for being disposed attached to the wall 20 or to the bottom 28 of a drinking cup 36, into which the beverage 24 is to be filled.

The term “chromatography paper” refers herein to a sheet characterized in changing the color thereof upon receiving a chemical substance.

Container 14 further includes chromatography paper 16, chromatography coating, or another chromatography substance, characterized in changing the color thereof upon presence of an undesired additive to beverage 24.

Container 14 is closed all around, except for an aperture closed by a one-way valve 12, for allowing beverage 24 of cup 36 enter container 14, for contacting chromatography paper 16. Beverage 24 which has entered container 14 is enumerated 24′.

One-way valve 12 does not allow the user to drink beverage 24′, which has entered container 14, for protecting the user from drinking a portion of the chemical components of chromatography paper 16, received by beverage 24′.

According to one embodiment, both wall 20 of cup 36 and container 14 are transparent, thus allowing the user to view chromatography paper 16, and the color change thereof. According to another embodiment, container 14 includes a top portion 26 only being transparent, through which the eye 28 of the user may view chromatography paper 16.

Container 14 may further include contact means 18, for contacting container 14 to the bottom 28 of cup 36, for disallowing container 14 to float. Contact means 18 may constitute a seal for maintaining cup 36 clean for next use.

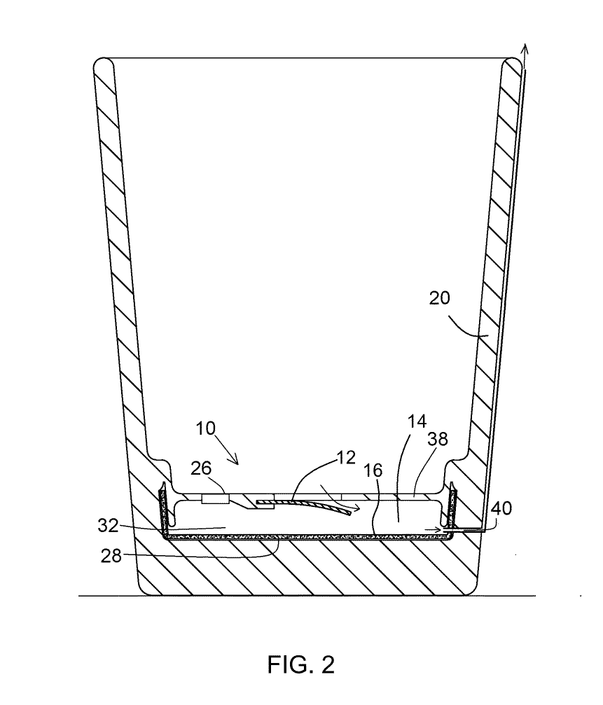

FIG. 2 is a sectional view of the apparatus for detecting undesired additives to a beverage, according to another embodiment.

According to another embodiment, apparatus 10 is an inherent element of cup 36.

According to this embodiment, cup 36 includes a top floor 38 including one-way valve 12; a three dimensional space 32 for containing tested beverage 24; chromatography paper 16; and bottom floor.

According to one embodiment apparatus 10 includes an air pipe 40, for releasing air, for allowing entrance of beverage 24. According to another embodiment container 14 is supplied vacuumed for allowing entrance of beverage 24.

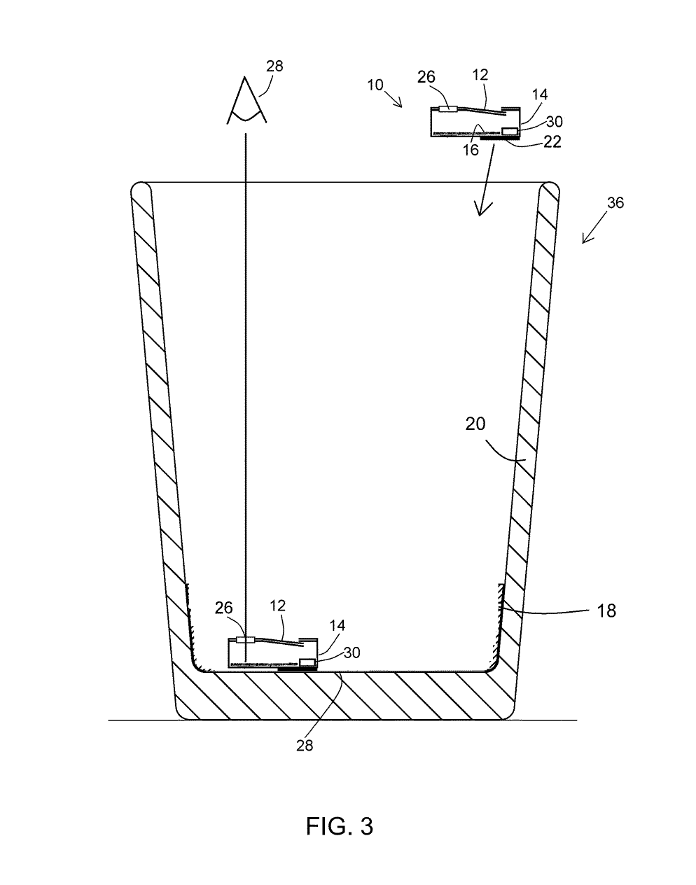

FIG. 3 is a sectional view of the apparatus for detecting undesired additives to a beverage, according to another embodiment.

According to another embodiment, apparatus 10 for detecting undesired additives to a beverage may constitute a small personal product, for inserting thereof into standard cup 36.

Container 14 may be entirely transparent and closed all around, except for one-way valve 12, and contains chromatography paper 16. Container 14 may include transparent portion 26.

Contact means 18 may constitute a weight 30, for forcing apparatus 10 to sink.

According to another embodiment, contact means 18 may constitute a sticker 22, for sticking apparatus 10 to the floor or wall of cup 36.

Thus, an embodiment of the invention is directed to a beverage test apparatus (10), comprising:
a container (14), for containing beverage (24′) to be tested;
an opening (34) disposed on the container (14), the opening (34) being covered by a one-way valve (12), for allowing entrance of the beverage (24′) into the container (14), and for disallowing exit therefrom; and
a chromatography substance (16) contained in the container (14), for changing a color of the chromatography substance (16) upon presence of a certain ingredient,
thereby a portion (24′) of beverage (24) poured into the cup (36) enters the container (14) and is tested by the chromatography substance (16),
and thereby the one-way valve (12) disallows access of the chromatography substance (16) to the beverage (24) being drunk by the user.

At least a portion (26) of said container (14) is transparent, for allowing a user (28) to view said chromatography substance (16) therethrough.

The container (14) may be an inherent element of the cup (36).

The beverage test apparatus (10) may further comprise:
drawing means (18, 30), for drawing the container (14) towards a wall (20) or towards a bottom (28) of the drinking cup (36).

The drawing means (18, 30) may comprise a weight (30) being sufficiently heavy for making the container sink (14), even prior to the entrance of the beverage (24) thereinto.

The drawing means (18, 30) may comprise contact means (18) for contacting the container to the wall (20) or to the bottom (28) of the drinking cup (36).

The drawing means (18, 30) may comprise a seal (18), for sealing the container to the wall or bottom of the cup (36).

The one-way valve (12) may comprise a leaf valve.

The chromatography substance (16) may comprise chromatography paper, chromatography coating; chromatography grains or another form allowing the user to view a change in the substance.

The beverage test apparatus (10) may further comprise:
a sticker (22) attached to the container (14), for sticking the container (14) to the wall (20) or to the bottom (28) of the drinking cup (36).

The beverage test apparatus (10) may further comprise:
an air pipe (40)), for releasing air, for allowing entrance of the beverage (24′).

According to another embodiment, the container (14) may be supplied vacuumed for allowing entrance of the beverage (24′).

In the figures and/or description herein, the following reference numerals (Reference Signs List) have been mentioned:
numeral 10 denotes a beverage test apparatus according to one embodiment of the invention;
numeral 12 denotes a one-way valve;
numeral 14 denotes a container;
numeral 16 denotes a chromatography substance, typically being chromatography test paper;
numeral 18 denotes a seal or glue or other attaching means, for attaching the container to the cup, so as not to disturb the user from drinking, once the beverage has been tested;
numeral 20 denotes the wall of the cup;
numeral 22 denotes a sticker, for sticking the beverage test apparatus to the floor or to a wall of the cup;
numeral 24 denotes the beverage poured into the cup from drinking;
numeral 24′ denotes a portion of the poured beverage, which as entered into the container;
numeral 26 denotes an area being a portion of the container, for viewing the color of the chromatography paper therethrough;
numeral 28 denotes the bottom of the cup;
numeral 30 denotes a weight, for sinking the container in the beverage;
numeral 32 denotes a three dimensional space for containing the beverage in the container;
numeral 34 denotes an opening on the container;
numeral 36 denotes the cup;
numeral 38 denotes a top floor; and
numeral 40 denotes an air pipe, for releasing air.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A beverage test apparatus, comprising:
a container, for containing beverage to be tested;
an opening disposed on said container, said opening being covered by a one-way valve, for allowing entrance of the beverage into said container, and for disallowing exit therefrom; and
a chromatography substance contained in said container, for changing a color of said chromatography substance upon presence of a certain ingredient,
thereby a portion of beverage poured into the cup enters said container and is tested by said chromatography substance,
and thereby said one-way valve disallows access of said chromatography substance to the beverage being drunk by the user.

2. A beverage test apparatus according to claim 1, wherein at least a portion of said container is transparent, for allowing a user to view said chromatography substance therethrough.

3. A beverage test apparatus according to claim 1, wherein said container in an inherent element of the cup.

4. A beverage test apparatus according to claim 1, further comprising:
drawing means, for drawing said container towards a wall or towards a bottom of the drinking cup.

5. A beverage test apparatus according to claim 4, wherein said drawing means comprises a weight being sufficiently heavy for making said container sink, even prior to the entrance of the beverage thereinto.

6. A beverage test apparatus according to claim 4, wherein said drawing means comprises contact means.

7. A beverage test apparatus according to claim 4, wherein said drawing means comprises a seal, for sealing said container to said wall or bottom of the cup.

8. A beverage test apparatus according to claim 1, wherein said one-way valve comprises a leaf valve.

9. A beverage test apparatus according to claim 1, wherein said chromatography substance comprises a member selected from a group consisting of: chromatography paper, chromatography coating, and chromatography grains.

10. A beverage test apparatus according to claim 1, further comprising:
a sticker attached to said container, for sticking said container to a wall or to a bottom of the drinking cup.

11. A beverage test apparatus according to claim 1, further comprising:
an air pipe, for releasing air, for allowing entrance of the beverage.

12. A beverage test apparatus according to claim 1, wherein said container is supplied vacuumed for allowing entrance of the beverage.
